(19) United States
(12) Patent Application Publication
(10) Pub. No.: US 2018/0352820 A1
(43) Pub. Date: Dec. 13, 2018

(54) Ready to Gel Konjac Flour

(71) Applicant: Corn Products Development, Inc., Westchester, IL (US)

(72) Inventor: Hongxin Jiang, Bridgewater, NJ (US)

(21) Appl. No.: 15/616,662

(22) Filed: Jun. 7, 2017

(51) Int. Cl. A21D 13/04; C08B 37/00; A23L 29/00

(52) U.S. Cl. CPC A21D 13/04; A23V 2002/00; A23L 29/00; C08B 37/009

(57) ABSTRACT

A method of making modified konjac glucomannan flour that acts a gelling agent. The method comprises mixing the flour with an alkali-alcohol solution for sufficient time and at sufficient temperature to deacetylate the glucomannan. The modified flour can then be recovered, neutralized, and milled to obtain modified konjac flour that acts a gelling agent. The gelling agent forms gels at high temperature when mixed with water and heated to above an activation temperature, and mixed for a period of time. The gels are useful in a variety of food products.

### BACKGROUND

### Field of the Invention

The present invention relates to a gelling agent made from modified konjac flour and methods for making those modifications. More specifically, this application discloses modifying the konjac flour in an alkali-alcohol solution so that the modified konjac glucomannan can be recovered and prepared to be a ready to gel konjac flour.

Konjac, Amorphophallus konjac, is a plant native to warm subtropical and tropical regions of East Asia. The plant produces large corms whose principle polysaccharide is glucomannan. Konjac is used to create flour, jelly, and the like, and can be used as a vegan substitute for gelatin.

Glucomannan is a long, branched polysaccharide comprising glucose and mannose. The structure, in relevant part is depicted in FIG. 1. Native konjac glucomannan is soluble in water, where it forms a viscous sol (about 8000 cps at 1% flour by weight in water at 20° C., after 1 hour). But it does not gel without modification. The prior art discloses that konjac sols subjected to aqueous, basic conditions will form gels. But the modified konjac glucomannan is unrecoverable from the gel. Additionally, the highly viscous solution is difficult to handle for further processing.

### SUMMARY

This specification discloses a method for processing konjac glucomannan to make a gelling agent. In embodiments native konjac flour is mixed with an alkali-alcohol solution and is heated to sufficient temperature and for sufficient time to modify the konjac glucomannan so that it forms a gelling agent. Compared to the prior art, the method allows for the modified konjac gelling agent to be easily recovery so that it can be milled to form a powdered gelling agent.

In an embodiment the process comprises mixing konjac flour with an alkali-alcohol solution to modify the konjac flour, neutralizing the solution, recovering the modified konjac glucomannan, rinsing it with an alcohol, drying it, and further milling it to obtain a powdered modified konjac glucomannan gelling agent (also called a ready-to-gel konjac flour). The reaction is run in basic solutions having a pH above 7 and preferably above 10, more preferably in a range between 12 and 13. The reaction can be run at temperatures between ambient and near boiling. In embodiments the reaction is run at ambient temperature, between 20° C. and 25° C. In other embodiments the reaction is run at high temperature, between 90° C. and 99° C.

This specification also discloses a gelling agent made from konjac glucomannan. To make the gelling agent, konjac flour is modified so that it has fewer acetyl groups attached to the polysaccharide backbone than native konjac glucomannan. In one embodiment the modified konjac glucomannan has an acetylation of less than 1.2%, preferably less than 0.5%, and more preferably between 0.25% and 0.10%.

This specification also discloses methods of making gels from the konjac glucomannan gelling agent. The modified konjac flour forms viscous sols in water. To make gels, the aqueous modified konjac flour solution is stirred and heated to above an activation temperature. In embodiments, the solution is heated to between 90 and 99° C. for more than 1 minute. The solution forms gels without cooling.

This specification also discloses products made from the gels as well as processes for making such product. Such products included foodstuffs, cosmetics and industrial products. The products are made by mixing the modified konjac flour gelling agent with an aqueous solution to form a viscous sol and heating the sol to above an activation temperature to form a gel.

### BRIEF DESCRIPTION OF THE DRAWINGS

FIG. 1 depicts the chemical structure of konjac glucomannan.

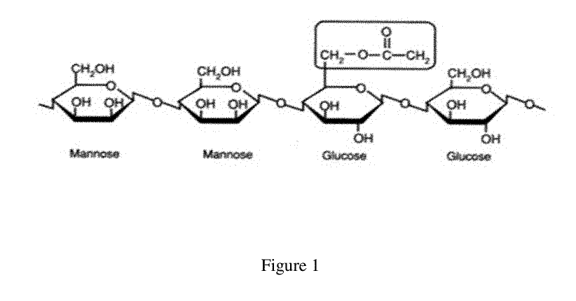

FIG. 2 is a photograph showing a konjac sol made from unmodified flour and a konjac glucomannan gel made from modified konjac glucomannoan flour.

### DETAILED DESCRIPTION

This specification discloses an improved process for modifying konjac flour that allows for more easily working with the flour in solution, more easily modifying the flour to make a gelling agent, and then more easily recovering the gelling agent. In one embodiment of the process konjac flour is mixed with an alkali-alcohol solution. The mixture is heated to sufficient temperature for sufficient time to modify the konjac flour to be a gelling agent.

In embodiments, the modified konjac flour is recovered by a filtration process or evaporative process.

In embodiments, the recovered modified konjac flour is neutralized by washing it in a buffered acidic solution until the pH of the recovered modified konjac flour is about neutral (i.e. pH between about 6 and about 8).

In embodiments, the gelling agent can then be washed and dried to form a powder.

More particularly, konjac flour is mixed in an alkali-alcohol solution. Any commonly available alcohol is suitable for the process. For example, methy, etheyl, propyl, and isopropyl alcohols may be used. The pH of the alcohol solution may be adjusted prior to or after the konjac flour is added. The reaction is run in basic solution (i.e. having pH greater than 7). Reaction time and yield improves with increased pH. In embodiments the pH is greater than 7.5. In embodiments the solution has pH greater than 10. In other embodiments the pH is greater than 11. In other embodiments the pH is between 12 and 13.

Konjac flours have different amounts of glucomannan. Standard commercial variants have between 55% and 85% glucomannan. The amount of glucomannan in the flour affects the yield of the gelling agent. So, konjac flours having higher glucomannan content are preferred.

In embodiments of the method, alcohol concentrations in the solution should be sufficiently high to minimize dissolution of konjac flour, and to aid in controlling the viscosity of the solution. In embodiments of the invention the alcohol concentration is at least 20% by volume (i.e between about 20% and about 100%). In embodiments it is about 50% by volume of alcohol. Konjac flour is mixed with the alcohol solution in a ratio of at least 1:2 and more typically in a 1:4 ratio.

Persons of ordinary skill in the art understand how to mix the alcohol and alkali solution to reach the desired pH range. For food applications, suitable food grade bases for use in the pH adjustment step include sodium hydroxide, sodium carbonate, sodium citrate, tetrasodium pyrophosphate, ammonium orthophosphate, disodium orthophosphate, trisodium phosphate, calcium carbonate, calcium hydroxide, potassium carbonate, potassium hydroxide, and potassium citrate. Particularly useful food grade bases are sodium hydroxide, sodium carbonate and potassium citrate.

Without being bound by theory, it is proposed that konjac glucomannan is deacetylated in solution. Native konjac glucomannan has an acetylation percentage of around 2%. Gels can be successfully made if the amount of acetylation is reduced to about 1.25% or less. More effective gelling agents are made with lower amounts of acetylation—i.e. stronger gels can be made with less gelling agents. So preferred amounts of acetylation are below 1%, more preferably below 0.5% and more preferably between about 0.25% and 0.10%

A person of ordinary skill in the art will understand that reaction times will vary with conditions. In embodiments konjac flours (85% glucomannan) having acetylation levels of between 0.25% and 0.20% were obtained by mixing with 50% ethanol solution (v/v, 80 g) at pH between 12 and 13 and heating to between about 25° C. to about 95° C. for between 1 to 3 hours.

The time to deacetylate the konjac flour will vary based on temperature and pH, typical reactions run for between 5 minutes and 3 hours. In one embodiment the reaction is run at temperatures between about 20° C. and about 25° C. for between about 2 and about 3 hours at pH of about 12.5 and above. In another embodiment the reaction is run at temperatures between 90° C. and 99° C. for between about 1 and about 2 hours at pH between about 11 and about 12.5.

The konjac may also be further modified, for example, chemically, enzymatically or physically to further adjust properties of the konjac.

Modified konjac flour is recovered by neutralizing the solution and filtering the suspended modified konjac flour. The recovered modified konjac flour is then washed in a suitable alcohol, such as methanol, ethanol, propanol, or isopropanol. The recovered modified konjac flour can be milled and sieved to make modified konjac glucomannan flour that acts a gelling agent.

Disclosed herein is a process for making gels from modified konjac flour. The modified konjac flour is water soluble, forming a viscous solution. A person of ordinary skill in the art would understand that gel strength and sol viscosity can be adjusted by using different amounts of the konjac flour gelling aging. In embodiments about 0.25% to about 10% (w/w) konjac gelling agent is added to water, preferably between about 0.5% and about 5% and more preferably between about 1% and about 3%. The modified konjac flour in solution is mixed for between about 0.5 and about 4 hours to develop viscosity.

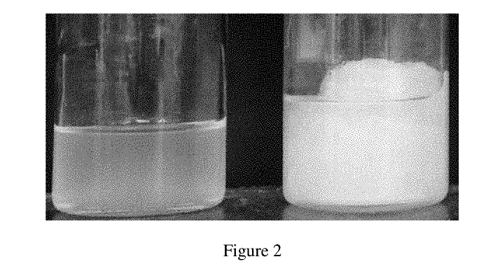

To form a gel, the aqueous modified konjac solution is heated at sufficient temperature and for sufficient time to activate the modified konjac flour (i.e. enable it to form gels). In embodiments the aqueous konjac solution is heated to temperatures of 50° C., but more typically between 90° C. and 99° C. (the activation temperature). In embodiments the modified konjac flour solution is maintained at or above the activation temperature for between 1 minute and about 60 minutes until the gel forms. Gels form at high temperature without cooling. In an exemplary embodiment a 1.5%, by weight, modified konjac flour/water slurry that was heated to 90° C. for 30 minutes formed a firm set, elastic, opaque gel. FIG. 2, image B depicts the gel made from modified konjac glucomannan according to the above conditions. Note that the presence of water in the beaker is due to the amount of water used exceeding the gelling capability of the modified konjac flour present.

The gelling agents made using the disclosed method can be used to form gels useful in various food applications. Examples include, but are not limited to, imitation cheeses, soups, desserts, sauces, gravies, pie fillings, yogurts, puddings, dressings, sausage casings, jellies, and gelatinized snack, and to replace gelatin, gums, and alginates in food.

The gelling agents may also be used in non-comestible applications, such as in cosmetics, personal hygiene or industrial detergents and conditioners, or in industrial, and in pharmaceutical or nutraceutical applications where gelling agents are of use. As examples, in addition to gels, konjac flour may be used to form suspensions, emulsions, and encapsulating compounds that are useful for making beadlets, microcapsules, capsules, tablets, solutions etc. that preserve and deliver active pharmaceutical ingredients, vitamins, minerals, nutritional supplements, conditioning agents, detergents, fragrances, colorants, ingredients for textile sizing, etc.

End products, whether comestible or not, using the konjac gelling agent are made using the konjac gelling agent alone in combination with other ingredients. The other ingredients will be dictated by the end use. Such ingredients may include modified and unmodified dairy products and proteins; sweeteners, including sugars, syrups, and their derivatives; fruit or fruit pectin etc.; seasoning salts, emulsifying salts and other, preservative salts; and animal and vegetable fats. Additionally, the konjac flour may be mixed with other starches, flours, protein concentrates and isolates that are modified (chemically, physically, or enzymatically) or not. The base flour may come from various sources, including pulses, wheat, oats, corn, sorgum, arrowroot, sago, potato, tapioca, rice, and waxy and high amylose variants. The modified konjac flour can be used as the sole gelling agent, or in combination with other gelling agents such as gelatin or modified and unmodified gums starches, fibers, and proteins. The konjac flour also may be combined with or plasticizers, including polyols (sorbitol, mannitol, glycerol, etc.). The gelling agent will be added as per the needs of the application but generally in amounts of between 0.1% and 50% flour (w/w) based on the end product, and all ranges in between.

Certain aspects of the present invention are further described by way of the following examples, which are provided as illustrations and should not be construed to limit the scope of the invention in any way. Persons of ordinary skill in the art will recognize that routine modifications may be made to the methods and materials used in the examples, which would still fall with in the spirit and scope of the present invention.

### Example 1—Treatement of Konjac Flour

konjac flour was prepared according to the following methods to remove the acetyl group. Konjac flour (85% glucomannan, 20 g) was mixed in a 1:4 ratio with 50% ethanol solution (80 g) at pH 11-12.5 (adjusted using 50% NaOH solution) at room temperature (about 22° C.) or at 95° C. for 1.5-2.5 hrs. The treated konjac flour was neutralized, washed with ethanol several times, and then dried in a hood at room temperature.

### Example 2—Effect of Treatment of Konjac Flour Acetylation

The amount of acetyl groups in the konjac flour was measured according to following method: Konjac flour was solubilized by an acid (4%, w/w, DCl/D₂O) in a pressure cooker. The solubilized samples were analyzed using a proton NMR spectrometer (Bruker AV-400). The acetyl levels of konjac flour samples are summarized in Table 1.

TABLE 1
Amount of Acetyl Groups in Konjac Flour.

| | pH of the | | | |
|---|---|---|---|---|
| | Konjac flour | Treatment | | |
| | and 50% ethanol | temperature | Treatment time | Acetylation* |
| Sample | mixture | (° C.) | (h) | (%) |
| 1 | 12.0 | 95 | 1.3 | 0.23 ± 0.01 |
| 2 | 11.0 | 95 | 2 | 1.13 ± 0.00 |
| 3 | 12.5 | 95 | 2 | 0.15 ± 0.01 |
| 4 | 12.5 | 25 | 2.5 | 0.16 ± 0.01 |
| Native | — | — | — | 1.86 ± 0.10 |
| Konjac | | | | |
| Flour | | | | |

*The same sample was tested twice for a standard deviation.

As seen, the native Konjac flour had 1.86% acetyl groups, which is higher than any of the alkali-alcohol treated samples. The four alkali-alcohol samples, samples 1, 2, 3, and 4, have acetyl levels of 0.23%, 1.13%, 0.15%, and 0.16%, respectively. This suggests that the treatment removes the acetyl group from the konjac glucomannan. Further, consideration of the results shows that higher pH solutions remove the acetyl group more efficiently. (Compare Sample 2, with Sample 3). Also, Sample 4 shows that sufficiently high pH the acetyl groups can be removed at room temperature.

### Example 3—Gel Formation

solutions made with modified and unmodified konjac flour were tested for the ability to form gels. The solutions were 1.5% konjac flour (w/w) in water. The solution was stirred for about 2.5 h at room temperature. Both treated and native solutions attained the high viscosity characteristic of konjac glucomannan sols. The solutions were then covered with foil and then heated in a boiling water bath for 30 min.

What is claimed is:

1. A method of making a modified konjac glucomannan comprising:
a) combining an unmodified konjac glucomannan with an alkaline alcohol to make a konjac/alcohol solution;
b) mixing the solution at sufficient temperature and for sufficient time to modify the konjac glucomannan; and
c) filtering the solution to recover the modified konjac glucomannan.

2. The method of claim 1 wherein the alkali-alcohol comprises ethanol.

3. The method of claim 1 wherein the alkali-alcohol solution comprises an ethanol solution having an ethanol concentration of between 20% and 100% ethanol.

4. The method of claim 1 wherein the alkali-alcohol solution has a pH between 7.5 and 12.5.

5. The method of claim 1 wherein the reaction is run at a temperature between 20° C. and 99° C.

6. The method of claim 1 wherein the reaction is run at a temperature between 20° C. and 25° C.

7. The method of claim 1 wherein the reaction is run at a temperature between 90° C. and 99° C.

8. The method of claim 1 wherein the reaction is run for between 5 minutes and 3 hours.

9. The method of claim 1 further comprising neutralizing the recovered modified konjac glucomannan, drying the neutralized konjac glucomannan, and milling the modified konjac glucomannan to produce a modified konjac glucomannan flour.

10. The method of claim 1 wherein the reaction is run for sufficient time to reduce the acetylation of the modified konjac glucomannan to below 1.25% by weight.

11. A method of making a gel comprising:
mixing water and a modified konjac glucomannan flour having an acetylation of 1.25% by weight; and
heating the mixture for sufficient time and at sufficient temperature to make a gel.

12. The method of claim 11 wherein the solution is heated for at least 5 minutes at a temperature of at least 50° C.

13. A method of making a food product comprising:
mixing water and a modified konjac glucomannan flour having an acetylation of less than 1.25% by weight; and
heating said the mixture for sufficient time and at sufficient temperature to make a gel.

14. A modified konjac flour comprising:
konjac glucomannan having an acetylation of less than 1.25% by weight.

15. A modified konjac flour made according to the process of claim 1.

16. The modified konjac flour of claim 14 further characterized by forming a solution when mixed with water at room temperature, and forming a gel when said solution is heated.

17. The modified konjac flour of claim 15 further characterized by forming a solution when mixed with water at room temperature, and forming a gel when said solution is heated.

18. The modified konjac glucomannan flour of claim 15 further characterized by forming a gel when said solution is heated for at least 5 minutes at a temperature of at least 50° C.

19. A gel comprising: water and a modified konjac glucomannan flour having an acetylation of less than 1.25% by weight.

20. A product comprising: water; and a modified konjac glucomannan flour having an acetylation of less than 1.25% by weight, and a second ingredient.
